(19) United States
(12) Patent Application Publication
(10) Pub. No.: US 2021/0373133 A1
(43) Pub. Date: Dec. 2, 2021

(54) RANGING APPARATUS

(71) Applicant: DENSO CORPORATION, Kariya-city (JP)

(72) Inventor: Masahiro YAMAMOTO, Kariya-city (JP)

(21) Appl. No.: 17/399,863

(22) Filed: Aug. 11, 2021

Related U.S. Application Data
(63) Continuation of application No. PCT/JP2020/005329, filed on Feb. 12, 2020.

(30) Foreign Application Priority Data
Feb. 13, 2019 (JP) 2019-023590

(51) Int. Cl. G01S 7/481; G01S 17/931; G01S 17/08

(52) U.S. Cl. CPC G01S 7/4813; G01S 7/4814; G01S 17/08; G01S 17/931

(57) ABSTRACT

A ranging apparatus works to measure a distance to an object and includes an emitter, a receiver, a housing, an emitting window, a receiving window, an emitting window heating wire, and an emitting window covering layer. The emitter outputs light. The receiver receives reflected light arising from reflection of the emitted light on the object. The housing has the emitter disposed therein. The emitting window is provided in the housing and configured to have the emitted light to be transmissible therethrough. The receiving window is provided in the housing and configured to have the reflected light to be transmissible therethrough toward the receiver. The emitting window heating wire adds heat to the emitting window. The emitting window covering layer covers the emitting window heating wire. The emitting window covering layer reflects the emitted light and the reflected light less than the emitting window heating wire.

### CROSS REFERENCE TO RELATED DOCUMENTS

The present application claims the benefit of priority of Japanese Patent Application No. 2019-23590 filed on Feb. 13, 2019, the disclosure of which is incorporated in its entirety herein by reference.

### TECHNICAL FIELD

This disclosure generally relates to a ranging apparatus.

### BACKGROUND ART

Ranging devices are known which measure a distance to an object. The ranging device works to emit a light beam. The light beam is reflected on the object to produce reflected light. The ranging device receives the reflected light and calculate the distance to the object as a function of a difference in time between when the light beam is emitted and when the reflected light is received.

The ranging device is usually equipped with a housing with an optical window. The light beam and the reflected light pass through the optical window. The ranging device, as disclosed in the patent literature 1, is equipped with a heater which supplies heat to the optical window to remove snow or ice from the optical window.

### PRIOR ART DOCUMENT

### Patent Literature

Patent Literature 1

Japanese translation of PCT internal application publication No. 2015-506459

### SUMMARY OF THE INVENTION

The inventor has made a study in detail and found the following problem. Specifically, an emitted light beam may be reflected on the heater to generate stray light in the housing. When the ranging device receives the stray light, it will result in a reduction in ranging performance thereof. It is, therefore, desirable in this disclosure to provide a ranging apparatus capable of minimizing the reduction in ranging performance arising from the stray light.

According to one aspect of this disclosure, there is provided a ranging apparatus which measures a distance to an object and comprises: (a) an emitter which emits light; (b) a receiver which receives reflected light which arises from reflection of the emitted light on the object; (c) a housing which is configured to have the emitter and the receiver disposed therein; (d) an emitting window which is provided in the housing and through which the emitted light is transmissible; (e) a receiving window which is provided in the housing and through which the reflected light is transmissible toward the receiver; (f) an emitting window heating wire which works to add heat to the emitting window; and (g) an emitting window covering layer which covers the emitting window heating wire and is configured to reflect the emitted light and the reflected light less than the emitting window heating wire.

The ranging apparatus according to one aspect of this disclosure works to minimize a reduction in ranging ability thereof caused by stray light.

### BRIEF DESCRIPTION OF THE DRAWINGS

FIG. 1 is a block diagram which shows a structure of a ranging apparatus.

FIG. 2 is a block diagram which shows a functional structure of a controller.

FIG. 3 is a perspective view which illustrates a structure of a housing.

FIG. 4 is a perspective view which illustrates a first portion, as viewed from inside it.

FIG. 5 is a sectional view taken along the line V-V in FIG. 4.

FIG. 6 is a sectional view taken along the line VI-VI in FIG. 4.

FIG. 7 is a sectional view taken along the line VII-VII in FIG. 4.

### EMBODIMENT FOR CARRYING OUT THE INVENTION

An embodiment of this disclosure will be described below with reference to the drawings.

### First Embodiment

### 1 Structure of Ranging Apparatus 1

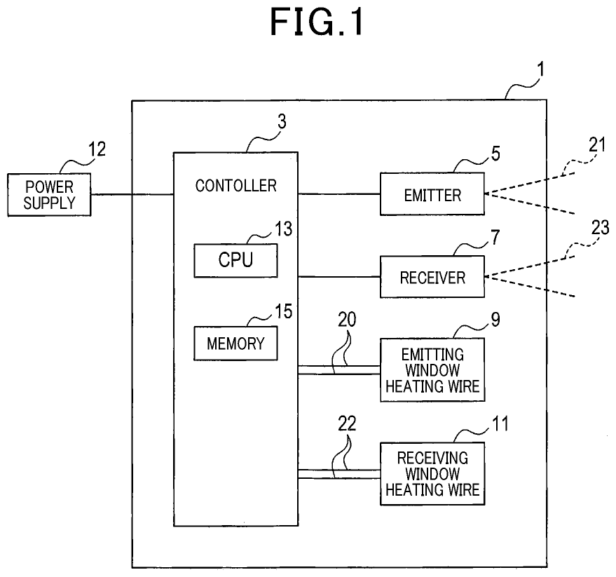

The structure of the ranging apparatus 1 will be described below with reference to FIGS. 1 to 7. The ranging apparatus 1 is engineered to measure a distance between itself and an object. The ranging apparatus 1 is implemented by, for example, a LiDAR. The ranging apparatus 1 is mounted in, for example, a vehicle. In such a case, the ranging apparatus 1 works to measure a distance between the vehicle and an object existing around the vehicle.

The ranging apparatus 1, as clearly illustrated in FIG. 1, includes the controller 3, the emitter 5, the receiver 7, the emitting window heating wire 9, and the receiving window heating wire 11.

The controller 3 is equipped with a microcomputer made up of the CPU 13 and the semiconductor memory 15, such as a RAM or a ROM.

The controller 3 performs various functions by executing programs using the CPU 13. The programs are stored in a non-transitory computer-readable recording medium. In this embodiment, the memory 15 is a non-transitory computer-readable recording medium which retains the programs therein. The programs are also executed to implement given methods. The controller 3 may be equipped with a single or a plurality of microcomputers.

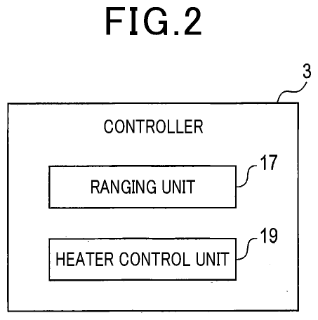

The controller 3, as illustrated in FIG. 2, includes the ranging unit 17 and the heater control unit 19. The controller 3 is, as can be seen in FIG. 1, supplied with electrical power from the external power supply 12. The controller 3 delivers electrical power to the emitting window heating wire 9 using the first power cable 20. The controller 3 also delivers electrical power to the receiving window heating wire 11 through the second power cable 22.

The emitter 5 works to emit the light 21 in the form of a laser beam. The emitted light 21 is infrared light. The receiver 7 receives the reflected light 23 and converts it into an electrical signal. The reflected light 23 is light arising from reflection of the emitted light 21 on an object.

The emitting window heating wire 9 works to add heat to the emitting window 45 which will be described later. The receiving window heating wire 11 works to add heat to the receiving window 47 which will be described later. The addition of heat from the emitting window heating wire 9 to the emitting window 45 removes snow or ice from the emitting window 45. The supply of heat from the receiving window heating wire 11 to the receiving window 47 receives snow or ice from the receiving window 47.

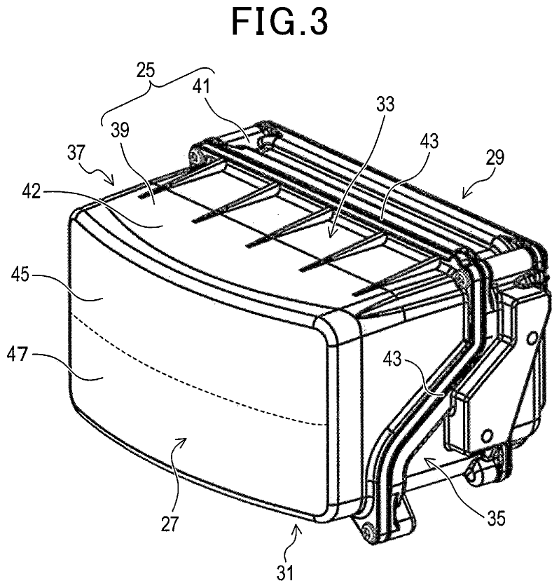

The ranging apparatus 1 is, as illustrated in FIG. 3, equipped with the housing 25. The emitter 5, the receiver 7, the emitting window heating wire 9, and the receiving window heating wire 11 are disposed in the housing 25. The controller 3 is arranged outside the housing 25. The housing 25 is of a cuboid shape. The housing 25 has the front surface 27, the back surface 29, the bottom surface 31, the upper surface 33, the first side surface 35, and the second side surface 37. The emitter 5 is arranged close to the upper surface 33 within the housing 25. The receiver 7 is arranged close to the bottom surface 31 within the housing 25.

The front surface 27 is made from resin through which the emitted light 21 and the reflected light 23 pass. The front surface 27 functions as an optical window. The front surface 27 has a horizontal cross section curved outward in the shape of a convex. The horizontal cross section is a cross section of the front surface 37 extending parallel to the bottom surface 31 and the upper surface 33. The back surface 29, the bottom surface 31, the upper surface 33, the first side surface 35, and the second side surface 37 are made from material through which the emitted light 21 and the reflected light 23 hardly pass.

The housing 25 includes the first portion 39 and the second portion 41. The first portion 39 includes the whole of the front surface 27, a portion of the bottom surface 31, a portion of the upper surface 33, a portion of the first side surface 35, and a portion of the second side surface 37.

The first portion 39 has a portion which occupies the portion of the bottom surface 31, the portion of the upper surface 33, the portion of the first side surface 35, and the portion of the second side surface 37 and forms the frame 42.

The second portion 41 includes the whole of the back surface 29, a portion of the bottom surface 31, a portion of the upper surface 33, a portion of the first side surface 35, and a portion of the second side surface 37. The surface 43 of a joint between the first portion 39 and the second portion 41 extends through the bottom surface 31, the first side surface 35, the upper surface 33, and the second side surface 37.

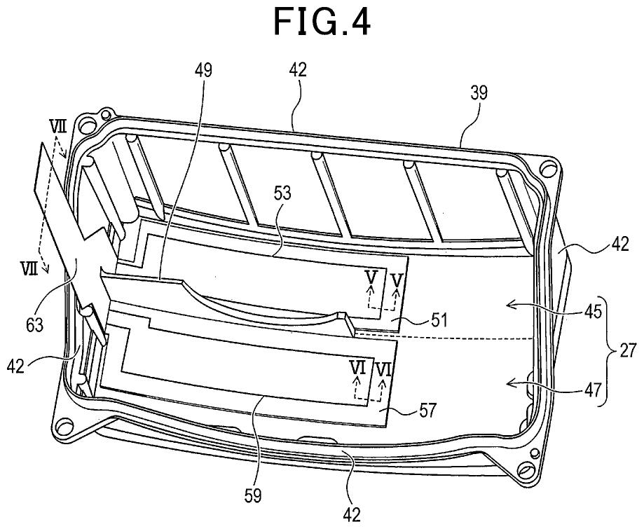

The front surface 27, as illustrated in FIGS. 3 and 4, has the emitting window 45 and the receiving window 47. The emitting window 45 occupies a portion of the front surface 27 which is located close to the upper surface 33. The receiving window 47 occupies a portion of the front surface 27 which is located close to the bottom surface 31.

The front surface 27, as clearly illustrated in FIG. 4, has the shielding plate 49 secured on an inner surface thereof. The inner surface is a portion of an inner surface of the housing 25. The shielding plate 49 is disposed along a boundary between the emitting window 45 and the receiving window 47. The shielding plate 49 extends from the front surface 27 toward the back surface 29. The shielding plate 49 is made from resinous material through which the emitted light 21 and the reflected light 23 hardly transmit. The shielding plate 49 works to stop the emitted light 21, as reflected by the emitting window 45, from traveling toward the receiver 7.

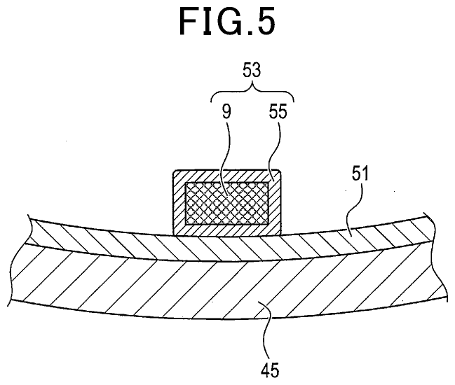

The emitting window 45, as illustrated in FIGS. 4 and 5, has the first transparent film 51 affixed to a portion of the inner surface thereof. The first transparent film 51 is made from resinous material through which the emitted light 21 and the reflected light 23 are transmissive. The first transparent film 51 has the first heater unit 53 secured on an inner surface thereof. The first heater unit 53 is designed to be of a line shape. The first heater unit 53 extends in a rectangular shape on the inner surface of the emitting window 45. The first heater unit 53, as illustrated in FIG. 5, includes the emitting window heating wire 9 and the emitting window covering layer 55. The emitting window heating wire 9 works to heat the emitting window 45. The emitting window covering layer 55 covers the emitting window heating wire 9. The emitting window covering layer 55 reflects the emitted light 21 or the reflected light 23 less than the emitting window heating wire 9.

It is advisable that the reflectance of the emitting window covering layer 55 to the emitted light 21 and the reflected light 23 (which will also be referred to as an emitting window covering layer reflectance) be selected to be lower than that of the emitting window heating wire 9 to the emitted light 21 and the reflected light 23 (which will also be referred to as a emitting window heating wire reflectance). The reflectance of the emitting window covering layer 55 is preferably set to 1.5% or less, more preferably 1% or less, and further more preferably 0.5% or less.

It is also advisable that the color of the emitting window covering layer 55 be black or in a RGB color space where an intensity of red is higher than those of green and blue.

The emitting window covering layer 55 is made of, for example, a coating of paint applied to an outer periphery of the emitting window heating wire 9. The emitting window covering layer 55 may be made by forming a coating on the outer periphery of the emitting window heating wire 9 using vapor deposition or sputtering techniques. The emitting window covering layer 55 may alternatively be made of a film attached to the outer periphery of the emitting window heating wire 9.

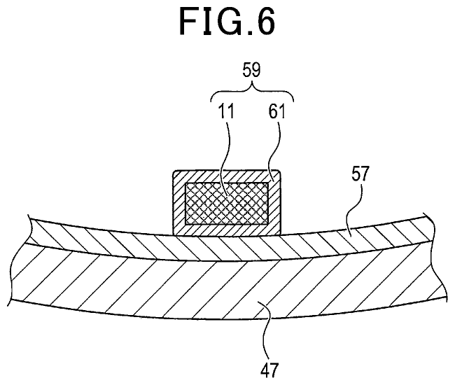

The receiving window 47, as illustrated in FIGS. 4 and 6, has the second transparent film 57 affixed to an inner surface thereof. The second transparent film 57 is made from resinous material through which the emitted light 21 and the reflected light 23 are transmissive. The second transparent film 57 has the second heater unit 59 secured to an inner surface thereof. The second heater unit 59 is made of a linear member. The second heater unit 59 extends on the inner surface of the receiving window 47 in a rectangular shape. The second heater unit 59, as illustrated in FIG. 6, includes the receiving window heating wire 11 and the receiving window covering layer 61. The receiving window heating wire 11 adds heat to the receiving window 47. The receiving window covering layer 61 covers the whole of the receiving window heating wire 11. The receiving window covering layer 61 reflects the emitted light 21 and the reflected light 23 less than the receiving window heating wire 11.

It is advisable that the reflectance of the receiving window covering layer 61 to the emitted light 21 and the reflected light 23 be lower than that of the receiving window heating wire 11 to the emitted light 21 and the reflected light 23. The reflectance of the receiving window covering layer 61 is preferably 1.5% or less, more preferably 1% or less, and further more preferably 0.5% or less.

It is also advisable that the color of the receiving window covering layer 61 be black or in a RGB color space where an intensity of red is higher than those of green and blue.

The receiving window covering layer 61 is made of, for example, a coating of paint applied to an outer periphery of the receiving window heating wire 11. The receiving window covering layer 61 may be made by forming a coating on the outer periphery of the receiving window heating wire 11 using vapor deposition or sputtering techniques. The receiving window covering layer 61 may alternatively be made of a film attached to the outer periphery of the receiving window heating wire 11.

The ranging apparatus 1 is, as illustrated in FIG. 4, equipped with the power conductor 63. The power conductor 63 is made of, for example, a flexible board. The power conductor 63 is connected to the emitting window heating wire 9 and the receiving window heating wire 11 near a boundary between the front surface 27 and the frame 42.

The power conductor 63 extends from the emitting window heating wire 9 and the receiving window heating wire 11 toward the back surface 29 within the housing 25. The power conductor 63 extends through an outlet hole formed in the back surface 29 outside the housing 25 and then connects with the controller 3.

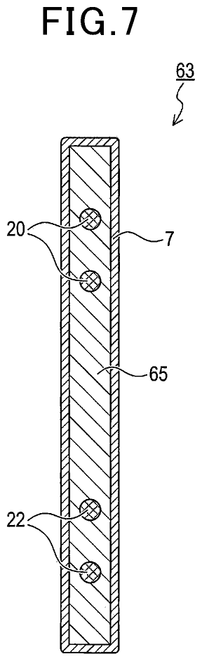

The power conductor 63, as illustrated in FIG. 7, includes the body 65, the first power cable 20, the second power cable 22, and the power conductor covering layer 67. The body 65 is made of a resinous strip member. The first power cable 20 and the second power cable 22 are embedded in the body 65 and extend in a lengthwise direction of the body 65. The first power cable 20 connects the controller 3 and the emitting window heating wire 9 together. The second power cable 22 connects the controller 3 and the receiving window heating wire 11 together.

The power conductor covering layer 67 covers the body 65, the first power cable 20, and the second power cable 22. The power conductor covering layer 67 reflects the emitted light 21 or the reflected light 23 less than the first power cable 20 and the second power cable 22.

It is advisable that the reflectance of the power conductor covering layer 67 to the emitted light 21 and the reflected light 23 be lower than those of the first power cable 20 and the second power cable 22 to the emitted light 21 and the reflected light 23. The reflectance of the power conductor covering layer 67 is preferably 1.5% or less, more preferably 1% or less, and further more preferably 0.5% or less.

It is also advisable that the color of the power conductor covering layer 67 be black or in a RGB color space where an intensity of red is higher than those of green and blue.

The power conductor covering layer 67 is made of, for example, a coating of paint applied to an outer periphery of the body 65. The power conductor covering layer 67 may be made by forming a coating on the outer periphery of the body 65 using vapor deposition or sputtering techniques. The power conductor covering layer 67 may alternatively be made of a film attached to the outer periphery of the body 65.

### 2 Tasks Performed by Ranging Apparatus

The ranging unit 17 works to emit the light 21 using the emitter 5. The emitted light 21 passes through the emitting window 45 and travels outside the ranging apparatus 1. A portion of the emitted light 21 is reflected on an object to produce the reflected light 23. A portion of the reflected light 23 passes through the receiving window 47 and travels within the housing 25. The receiver 7 receives the reflected light 23 and converts it into an electrical signal. The receiver 7 then outputs the electrical signal to the ranging unit 17. The ranging unit 17 uses the electrical signal to calculate a distance to the object. The heater control unit 19 controls the degree of electrical energization of the emitting window heating wire 9 and the receiving window heating wire 11.

### 3 Beneficial Advantages Offered by Ranging Apparatus

1A) The ranging apparatus 1 is equipped with the emitting window covering layer 55. The emitting window covering layer 55 covers the emitting window heating wire 9. The emitting window covering layer 55 is configured to reflect the emitted light 21 and the reflected light 23 less than the emitting window heating wire 9. The ranging apparatus 1, therefore, reduces the degree of reflection of the emitted light 21 or the reflected light 23 on the emitting window heating wire 9, thereby minimizing a risk that stray light may occur within the housing 25. This ensures the stability of ability of the ranging apparatus 1 to measure the distance to an object.
1B) The reflectance of the emitting window covering layer 55 is selected to be 1.5% or less. This enables the ranging apparatus 1 to reduce the degree of reflection of the emitted light 21 or the reflected light 23 on the emitting window heating wire 9.
1C) The color of the emitting window covering layer 55 is selected to be black or in a RGB color space where an intensity of red is higher than those of green and blue. This enables the ranging apparatus 1 to further reduce the degree of reflection of the emitted light 21 or the reflected light 23 on the emitting window heating wire 9.
1D) The ranging apparatus 1 is equipped with the receiving window covering layer 61. The receiving window covering layer 61 covers the receiving window heating wire 11. The receiving window covering layer 61 is configured to reflect the emitted light 21 or the reflected light 23 less than the receiving window heating wire 11. The ranging apparatus 1, therefore, reduces the degree of reflection of the emitted light 21 or the reflected light 23 on the receiving window heating wire 11, thereby minimizing a risk that stray light may be generated within the housing 25. This minimizes a reduction in ability of the ranging apparatus 1 to measure the distance to an object which arises from the stray light.
1E) The ranging apparatus 1 is equipped with the power conductor covering layer 67. The power conductor covering layer 67 covers the first power cable 20 and the second power cable 22. The power conductor covering layer 67 is configured to reflect the emitted light 21 or the reflected light 23 less than the first power cable 20 and the second power cable 22. The ranging apparatus 1, therefore, reduces the degree of reflection of the emitted light 21 or the reflected light 23 on the first power cable 20 and the second power cable 22, thereby minimizing a risk that stray light may be generated within the housing 25. This minimizes a reduction in ability of the ranging apparatus 1 to measure the distance to an object which arises from the stray light.

### OTHER EMBODIMENTS

The above discussion has referred to the embodiments in this disclosure, but however, this disclosure is not limited to the above embodiments and may be realized in various ways without departing from the principle of the disclosure.
1) The ranging apparatus 1 may be designed as a ranging device other than a LiDAR device. The emitted light may be light having a wavelength other than that of infrared light
2) The ranging apparatus 1 may be designed to include only one or none of the receiving window covering layer 61 and the power conductor covering layer 67.
3) The emitting window covering layer 55 may be configured to cover only a portion of the outer periphery of the emitting window heating wire 9. For instance, the emitting window covering layer 55 may cover a portion of the outer periphery of the emitting window heating wire 9 which faces the back surface 29.

The receiving window covering layer 61 may be configured to cover only a portion of the outer periphery of the receiving window heating wire 11. For example, the receiving window covering layer 61 may cover a portion of the outer periphery of the receiving window heating wire 11 which faces the back surface 29.

The power conductor covering layer 67 may be configured to cover only a portion of the outer periphery of the body 65. For instance, the power conductor covering layer 67 may cover a portion of the outer periphery of the body 65 which faces the frame 42.
4) The shielding plate 49 may be firmly secured to the second portion 41.
5) The operations of the controller 3 in this embodiment may be realized by a special purpose computer which is equipped with a processor and a memory and programmed to execute one or a plurality of tasks created by computer-executed programs or alternatively established by a special purpose computer equipped with a processor made of one or a plurality of hardware logical circuits. The controllers or operations may alternatively be realized by a combination of an assembly of a processor with a memory which is programmed to perform one or a plurality of tasks and a processor made of one or a plurality of hardware logical circuits. Computer-executed programs may be stored as computer executed instructions in a non-transitory computer readable medium. The means for performing the functions of parts of the controller 3 need not necessarily include software, but may be realized one or a plurality of hardware devices.
6) The above functions performed by one of the component parts in the above embodiments may alternatively achieved by two or more of the component parts. One of the functions performed by each of the component parts may be achieved by a combination of two or more of the component parts. The functions performed by two or more of the component parts may be achieved by a specified one of the component parts. At least one of the component parts in each of the above embodiment may be omitted or replaced with that in another embodiment.
7) The above described ranging apparatus 1, a system including the ranging apparatus 1, computer-executed programs constituting the controller 3, a non-transitory computer-readable recording medium, such as a semiconductor memory, which retains the programs therein, a ranging method, a production method of the ranging apparatus may realize this disclosure.

What is claimed is:

1. A ranging apparatus which measures a distance to an object, comprising:
an emitter which emits light;
a receiver which receives reflected light which arises from reflection of the emitted light on the object;
a housing which is configured to have the emitter and the receiver disposed therein;
an emitting window which is provided in the housing and through which the emitted light is transmissible;
a receiving window which is provided in the housing and through which the reflected light is transmissible toward the receiver;
an emitting window heating wire which works to supply heat to the emitting window; and
an emitting window covering layer which covers the emitting window heating wire and is configured to reflect the emitted light and the reflected light less than the emitting window heating wire does.

2. The ranging apparatus as set forth in claim 1, wherein the emitting window covering layer has a reflectance of 1.5% or less to the emitted light and the reflected light.

3. The ranging apparatus as set forth in claim 1, wherein color of the emitting window covering layer is black or in a RGB color space where an intensity of red is higher than those of green and blue.

4. The ranging apparatus as set forth in claim 1, further comprising:
a receiving window heating wire which works to add heat to the receiving window; and
a receiving window covering layer which covers the receiving window heating wire and is configured to reflect the emitted light and the reflected light less than the receiving window heating wire.

5. The ranging apparatus as set forth in claim 1, further comprising:
a power cable which is connected to the emitting window heating wire and passes inside the housing; and
a power conductor covering layer which covers the power cable and is configured to reflect the emitted light and the reflected light less than the power cable.
